(19) United States
(12) Patent Application Publication
(10) Pub. No.: US 2023/0069160 A1
(43) Pub. Date: Mar. 2, 2023

(54) Oil Caddy Device

(71) Applicants: Sean Greene, Las Vegas, NV (US); Phyllis Greene, Las Vegas, NV (US)

(72) Inventors: Sean Greene, Las Vegas, NV (US); Phyllis Greene, Las Vegas, NV (US)

(21) Appl. No.: 17/552,434

(22) Filed: Dec. 16, 2021

Related U.S. Application Data
(60) Provisional application No. 63/238,417, filed on Aug. 30, 2021.

(51) Int. Cl. B62B 3/10; B60S 5/00

(52) U.S. Cl. CPC B62B 3/104; B62B 3/102; B60S 5/00

(57) ABSTRACT

The present invention relates generally to an oil caddy device that is comprised of a body that has a top surface comprised of at least one continuous opening, and a bottom surface comprised of a mat, a rear surface and two generally parallel side surfaces. The body of the device further preferably resembles a two-tiered shelving system, and is made of sheet metal, such that it can attach to any wall or surface. The device is also comprised of a storage system that allows funnels and other oil change equipment to be stored, while excess fluid drips out of them into a collection bin. In this manner, the device can be used in any garage or work area, such that a user may change vehicle fluids without worrying about creating an unsanitary or potentially dangerous environment.

### CROSS-REFERENCE TO RELATED APPLICATION

The present application claims priority to, and the benefit of, U.S. Provisional Application No. 63/238,417, which was filed on Aug. 30, 2021 and is incorporated herein by reference in its entirety.

### FIELD OF THE INVENTION

The present invention relates generally to the field of oil pan holders. More specifically, the present invention relates to an oil caddy device. The body of the device further preferably resembles a two-tiered shelving system that is made of sheet metal, such that it can easily attach to any wall or surface. The device is also comprised of a storage system that allows funnels and other oil change equipment to be stored while excess fluid drips out of them and into a collection bin. In this manner, the device can be used in any garage or work area such that a person may change fluids of vehicles without worrying about creating an unsanitary or potentially dangerous environment. Accordingly, the present disclosure makes specific reference thereto. Nonetheless, it is to be appreciated that aspects of the present invention are also equally applicable to other like applications, devices and methods of manufacture.

### BACKGROUND

Vehicles and machinery typically require a lubricant and other fluids to run properly and efficiently. However, changing these fluids can be a difficult, time-consuming, messy and frustrating process for even professional mechanics. If done improperly, oil can spill on the floor and leave a stain that is nearly impossible to remove. Common items required to perform fluid maintenance, include drain pans, funnels, filters, wrenches, etc., may also easily get lost or misplaced, creating an unsanitary and potentially dangerous work environment. Without thoroughly cleaning all items involved in a fluid change, excess fluid may drip onto the floor or other items while in storage. Further, traditional storage units for this type of equipment can be expensive and bulky, taking up valuable space in a garage.

Therefore, there exists a long-felt need in the art for an improved oil caddy device. There also exists a long-felt need in the art for an oil caddy device capable of storing and organizing oil pans, drains, funnels, and other oil-changing tools and accessories in a compact and space-saving manner. Further, there exists a long-felt need in the art for an oil caddy device that can store oil change equipment, such that any excess fluid can be collected without spilling onto the floor. In addition, there exists a long-felt need in the art for an oil caddy device that organizes oil change equipment, such that one can easily tell if items are missing or misplaced, creating a safer and more sanitary work environment.

The subject matter disclosed and claimed herein, in one embodiment thereof, comprises an oil caddy device. The device is comprised of a body that has a top surface comprised of at least one continuous opening, a bottom surface comprised of a mat, a rear surface and a pair of generally parallel side surfaces. The body of the device further preferably resembles a two-tiered shelving unit and is made of sheet metal, such that it can be easily attached to a wall or surface. The device is also comprised of continuous openings in which funnels and other equipment may be stored as they drip excess fluid into a collection unit on the surface below. In this manner, the device can be used in any garage or work area, such that a mechanic may change vehicle fluids without requiring excessive cleaning up afterwards.

In this manner, the oil caddy device of the present invention accomplishes all the forgoing objectives and provides an improved means to store oil change tools and accessories. Further, the device organizes oil change equipment, such that excess fluid remaining in the equipment gets collected without making a mess or spilling onto the floor surface. In addition, the device organizes the oil change equipment in a compact and space-saving manner, such that missing items are more easily noticed and can be replaced.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an oil caddy device that allows oil change equipment to be stored in an organized manner, such that excess fluid does not spill onto the floor and missing items are more easily identified. The device is comprised of a body that has a top surface comprised of at least one continuous opening, and a bottom surface comprised of a mat, a rear surface, and a pair of generally parallel side surfaces. In differing embodiments, the body may have the appearance of a multi-tiered shelving unit. However, in the preferred embodiment the body is comprised of two shelves. The body may also be made of a plurality of materials. However, the body is preferably made of sheet metal. In addition, any surface of the body may be comprised of a plurality of indicia, such as patterns, logos, emblems, images, symbols, designs, letters, words, characters, animals, advertisements, brands, etc.

The body is comprised of a top surface further comprised of at least one continuous opening capable of receiving and storing funnels and other oil change equipment. In one potential embodiment, the continuous opening may be lined with a gasket to better secure the funnels in place. A bottom surface positioned below the top surface houses an oil pan in which the funnels and other equipment stored above may drip into. In one potential embodiment, the oil pan may sit on a textured mat to prevent it from sliding off the bottom surface. A rear surface and two generally parallel side surfaces help to support the device further. The rear surface is comprised of at least one continuous opening in which fasteners may be inserted to attach the device to a wall. The side surfaces provide additional storage for tools and other equipment. Further, at least one hook is attached to the side surfaces, such that tools and other equipment may be hung. In addition, the side surfaces may be magnetic or a magnet may be attached to the side surfaces, such that tools, a tool tray, or other equipment may be attached magnetically to the side surfaces of the device.

Accordingly, the oil caddy device of the present invention is particularly advantageous as it provides an improved means to store oil change tools and accessories. Further, the device better organizes oil change equipment in a compact manner, such that items are easily identified. In addition, the device organizes oil change equipment, such that excess fluid remaining in the equipment is collected without making a mess or spilling onto the floor. In this manner, the oil caddy device overcomes the limitations of existing devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed, and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the oil caddy device of the present invention in accordance with the disclosed architecture;

FIG. 2 illustrates a rear perspective view of one potential embodiment of the oil caddy device of the present invention in accordance with the disclosed architecture;

FIG. 3 illustrates a side perspective view of one potential embodiment of the oil caddy device of the present invention in accordance with the disclosed architecture; and

FIG. 4 illustrates a perspective view of one potential embodiment of the oil caddy device of the present invention in use in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved oil caddy device. There also exists a long-felt need in the art for an oil caddy device capable of storing and organizing oil pans, drains, funnels and other oil-changing tools and accessories in a compact and space-saving manner. Further, there exists a long-felt need in the art for an oil caddy device that can store oil change equipment, such that any excess fluid is collected without spilling onto the floor. In addition, there exists a long-felt need in the art for an oil caddy device that organizes oil change equipment, such that a user can easily tell if items are missing or misplaced, creating a safer and more sanitary environment.

The present invention, in one exemplary embodiment, is comprised of an oil caddy device that allows oil change equipment to be stored in an organized manner, such that excess fluid does not spill onto the floor and missing items are more easily identified. The device is comprised of a body that has a top surface comprised of at least one continuous opening, and a bottom surface comprised of a mat, a rear surface and a pair of generally parallel side surfaces. In differing embodiments, the body may have the appearance of a shelving unit, and in the preferred embodiment the body has two shelves that act as storage containers for external equipment. The body may also be made of a plurality of materials, but is preferably made of a sheet metal. In addition, any surface of the body may be comprised of a plurality of indicia, such as patterns, logos, emblems, images, symbols, designs, letters, words, characters, animals, advertisements, brands, etc.

Furthermore, the body is a storage unit for general oil change equipment. A top surface of the body is comprised of at least one continuous opening in which funnels or other equipment that may contain excess fluid may be stored. In one potential embodiment, the continuous opening may be lined with a gasket to prevent the device from slipping through or tipping over. A bottom surface of the body is positioned below the top surface, such that equipment hanging from the top surface does not prevent equipment from being stored on the bottom surface as well. The bottom surface may also fit an oil pan to collect excess fluid that may drip from the funnels and other equipment stored on the top shelf. In one potential embodiment, a textured mat may lay on the bottom surface to prevent an oil pan from tipping, sliding, or spilling over. The mat may be manufactured of a material that increases the grip on the body of the device, or it may be fastened to the bottom surface of the body in another potential embodiment.

Further, a rear surface and two generally parallel side surfaces help to support the device and attach it securely to a wall. The rear surface is comprised of at least one continuous opening in which at least one fastener may be inserted to secure the device to a wall. The side surfaces further help stabilize and support the top and bottom surfaces, as well as provide additional storage for other equipment and tools that may be necessary for an oil change. The side surfaces have at least one hook in which tools can be hung from. In another potential embodiment, the side surfaces may be made of a magnetic material or may be comprised of a magnet, such that metal tools can magnetically secure to the side surfaces of the device. In addition, a tool tray capable of storing common tools may be attached to the side surfaces via magnetic attraction.

Accordingly, the oil caddy device of the present invention is particularly advantageous as it provides an improved means to store oil change tools and accessories. Further, the device organizes oil change equipment in a tiered manner, such that gravity forces excess fluid remaining in the equipment into a collection bin, such as to not make a mess or spill onto the floor. In addition, the device organizes oil change equipment in a manner, such that missing items are more easily identified. Therefore, the device eliminates the need for excessive cleaning and a potentially dangerous environment after changing the oil or other fluids of a vehicle.

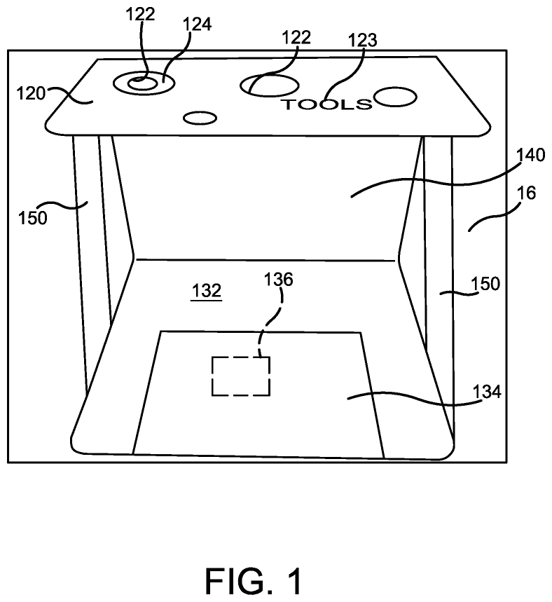

Referring initially to the drawings, FIG. 1 illustrates a front perspective view of one embodiment of the oil caddy device 100 of the present invention. The oil caddy device 100 is comprised of a body 110 that has a top surface 120 comprised of at least one continuous opening 122, and a bottom surface 130 comprised of a mat 134, a rear surface 140 and a pair of generally parallel side surfaces 150. In differing embodiments, the body 110 may have a plurality of shelves and organizational surfaces 120, 130. Further, the body 110 may have any suitable number of shelves or organizational surfaces as is known in the art. Furthermore, the body 110 may be manufactured of a plurality of materials such as, but not limited to, wood, plastic, acrylic, stainless steel, iron, copper, aluminum, etc., or any other suitable material as is known in the art, but is preferably made of a sheet metal. In addition, the body 110 may be transparent, semi-transparent, or opaque in differing embodiments, depending on the wants and/or needs of a user. Furthermore, any surface 120, 130, 140, 150 of the body 110 may be comprised of any number of indicia 123 in the form of patterns, logos, emblems, images, symbols, designs, letters, words, characters, animals, advertisements, brands, etc., or any other suitable indicia as is known in the art.

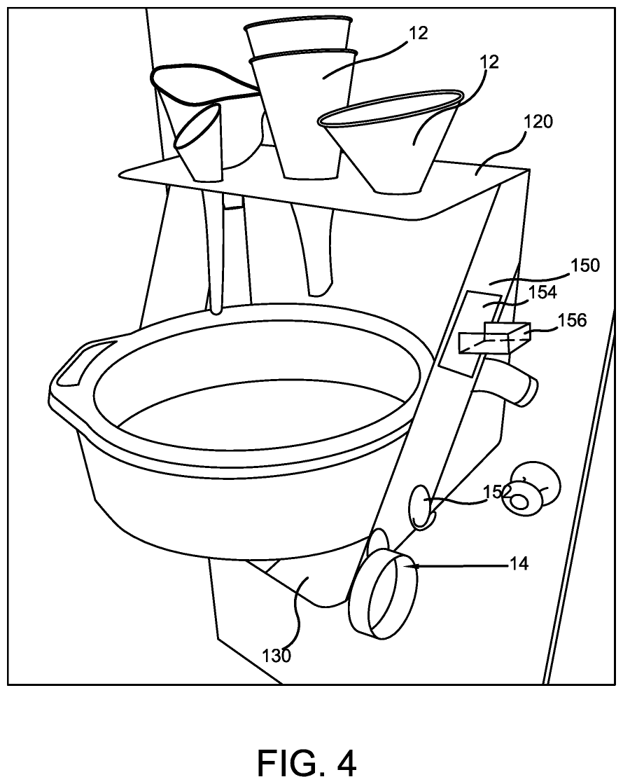

In the preferred embodiment of the device 100, shown in FIGS. 1-3, the body 110 is made of sheet metal and is capable of being mounted to a wall 16 or other suitable surface. A top surface 120 of the body 110 is comprised of at least one continuous opening 122 capable of storing at least one funnel 12 (shown in FIG. 4) and/or at least one suitable tapered oil change equipment device. It should be noted that in one embodiment, the device 100 may have multiple top surfaces 120 arranged in a tiered fashion, similar to organizational shelves. In another embodiment, a rubber gasket 124 may line the continuous openings 122, such that the gasket 124 tightens around the funnel 12 to prevent the funnel 12 or other suitable tool or device from tipping over or sliding through the continuous opening 122. A bottom surface 130 of the body 110 sits directly below the top surface 120, at a predetermined height. An oil pan 10 (shown in FIG. 4) may sit on the bottom surface 130, such that any excess fluids left in the funnels 12 and other tools and equipment stored in the continuous openings 122 of the top surface 120, may drip into the oil pan 10 to maintain a sanitary environment.

In one potential embodiment, the top surface 132 of the bottom surface 130 may be covered with a rubber mat 134 that is fixedly or removably-attached to the bottom surface 130. The mat 134 may be textured with several protrusions on the top and/or bottom surface of the mat 134 to create a textured surface, to prevent an oil pan 10 sitting on the mat 134 from sliding off the bottom surface 130 and/or to prevent the mat 134 from sliding off the bottom surface 130 itself. In addition, the mat 134 may further comprise at least one fastener 136 that secures the mat 134 to the bottom surface 130. The fastener 136 may be any suitable adhesive as is known in the art, which would allow the mat 134 to stick to the bottom surface 130, or the fastener 136 may be a screw, bolt, nail, anchor, rivet, magnet, hook and loop, etc., or any other suitable fastener as is known in the art.

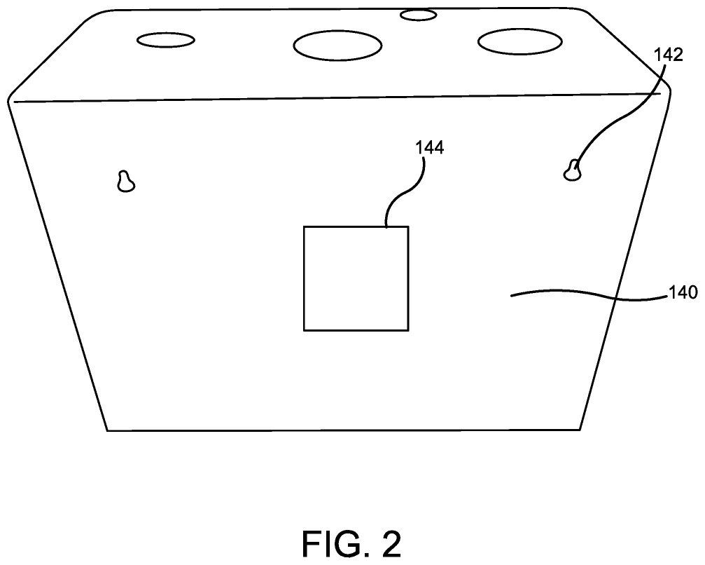

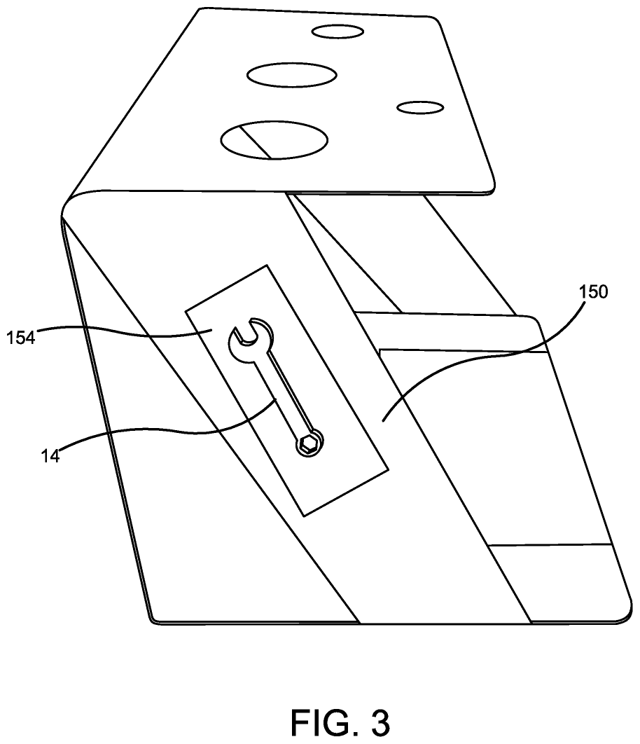

FIG. 2 illustrates a rear perspective view of one embodiment of the oil caddy device 100 of the present invention. The device 100 comprises a rear surface 140 and two generally parallel side surfaces 150 (shown in FIG. 3), which further support the device 100. The rear surface 140 is comprised of at least one continuous opening 142, in which at least one fastener 144 may be inserted through to secure the device 100 to a wall 16. In one embodiment, the fastener 144 may be a plurality of fasteners, such as but not limited to: a screw, a bolt, a nail, an anchor, a rivet, a hook and loop fastener, a magnet, a liquid adhesive, etc., or any other suitable fastener as is known in the art. Furthermore, a suitable adhesive fastener 144 as is known in the art can be applied directly to the rear surface 140, such that the device 100 can be mounted securely on a wall 16 or other suitable surface via this adhesive.

FIG. 3 illustrates a side perspective view of one embodiment of the oil caddy device 100 of the present invention. As stated supra, the device 100 comprises a rear surface 140 (shown in FIG. 2) and two generally parallel side surfaces 150 which further support the device 100. The rear surface is comprised of at least one continuous opening 142 in which at least one fastener 144 is inserted through, to secure the device 100 to a wall 16. The generally parallel side surfaces 150 act to further stabilize the device 100. In differing embodiments, the side surfaces 150 may be any suitable shape as is known in the art, such as a square, rectangle, triangle, or diagonal member, etc., such that the items stored on the surfaces 120, 130 may or may not be inaccessible from the side. The side surfaces 150 may further be manufactured of a magnetic material or contain at least one magnet 154, such that tools 14 or a tool tray 156 may magnetically attach to the side surfaces 150 of the body 110.

FIG. 4 illustrates a perspective view of one embodiment of the oil caddy device 100 of the present invention in use. The body 110 of the device 100 is made of sheet metal and is capable of being mounted to a wall 16 or other suitable surface. A top surface 120 of the body 110 is comprised of at least one continuous opening 122 capable of storing at least one funnel 12 and/or at least one suitable tapered oil change equipment device. It should be noted that in one embodiment, the device 100 may have multiple top surfaces 120 arranged in a tiered fashion, similar to organizational shelves. A bottom surface 130 of the body 110 sits directly below the top surface 120, at a predetermined height. An oil pan 10 may sit on the bottom surface 130, such that any excess fluids left in the funnels 12 and other tools and equipment stored in the continuous openings 122 of the top surface 120, may drip into the oil pan 10 to maintain a sanitary environment. In addition, the body 110 comprises side surfaces 150 for extra stability. The side surfaces 150 comprise at least one hook 152, such that tools 14 and other equipment or devices may be hung from the device 100. In another embodiment of the device 100, the side surfaces 150 may contain at least one magnet 154 which allows tools 14 or a tool tray 156 to be magnetically-secured to the side surfaces 150.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “oil caddy device” and “device” are interchangeable and refer to the oil caddy device 100 of the present invention.

Notwithstanding the forgoing, the oil caddy device 100 of the present invention and its various components can be of any suitable size and configuration as is known in the art without affecting the overall concept of the invention, provided that they accomplish the above-stated objectives. One of ordinary skill in the art will appreciate that the size, configuration and material of the oil caddy device 100 as shown in FIGS. 1-4 is for illustrative purposes only, and that many other sizes and shapes of the oil caddy device 100 are well within the scope of the present disclosure. Although the dimensions of the oil caddy device 100 are important design parameters for user convenience, the oil caddy device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A oil caddy device comprising:
a body further comprised of:
a top surface comprising at least one continuous opening;
a bottom surface;
a rear surface comprising at least one continuous opening;
a pair of generally parallel side surfaces; and
a mat that sits on the bottom surface and which is positioned below the at least one continuous opening of the top surface.

2. The oil caddy device of claim 1, wherein the at least one continuous opening of the top surface receives at least one funnel.

3. The oil caddy device of claim 2, wherein an oil pan is positioned on the mat, below the at least one continuous opening of the top surface.

4. The oil caddy device of claim 3, wherein oil from the at least one funnel can drip into the oil pan positioned on the mat.

5. A oil caddy device comprising:
a body further comprised of:
a top surface comprising at least one continuous opening that has a rubber gasket;
a bottom surface;
a rear surface comprising at least one continuous opening;
a pair of generally parallel side surfaces comprising at least one magnet;
an oil pan; and
a mat that can be fixedly secured to the bottom surface and positioned below the at least one continuous opening of the top surface.

6. The oil caddy device of claim 5, wherein the at least one continuous opening of the rear surface comprises at least one fastener to secure the oil caddy device to a wall.

7. The oil caddy device of claim 5, wherein the at least one magnet of the pair of generally parallel side surfaces allows a tool to be magnetically stored on the pair of generally parallel side surfaces.

8. The oil caddy device of claim 7, wherein the at least one magnet of the pair of generally parallel side surfaces allows at least one magnetic tool tray to be magnetically stored on the pair of generally parallel side surfaces.

9. The oil caddy device of claim 5, wherein the at least one continuous opening of the top surface receives at least one funnel.

10. The oil caddy device of claim 9, wherein the rubber gasket further secures the at least one funnel within the at least one continuous opening.

11. The oil caddy device of claim 10, wherein the oil pan is positioned on the mat.

12. The oil caddy device of claim 11, wherein oil from the at least one funnel drips into the oil pan positioned on the mat.

13. A oil caddy device comprising:
a body further comprised of:
a top surface comprising at least one continuous opening that receives at least one funnel and a rubber gasket that secures the at least one funnel within the at least one continuous opening;
a bottom surface;
a rear surface comprising at least one continuous opening;
a pair of magnetic, generally parallel side surfaces comprising at least one magnetic tool tray;
an oil pan; and
a mat that can be removably secured to the bottom surface and is positioned below the at least one continuous opening of the top surface.

14. The oil caddy device of claim 13, wherein the oil pan is positioned on the mat.

15. The oil caddy device of claim 14, wherein oil from the at least one funnel drips into the oil pan positioned on the mat.

16. The oil caddy device of claim 13, wherein the at least one magnetic tool tray can be used to store a tool.

17. The oil caddy device of claim 13, wherein the at least one continuous opening of the rear surface comprises at least one fastener which secures the oil caddy device to a wall.

18. The oil caddy device of claim 13, wherein the pair of magnetic, generally parallel side surfaces are diagonal in shape.

19. The oil caddy device of claim 13, wherein the mat is removably secured to the bottom surface by at least one fastener.

20. The oil caddy device of claim 13, wherein the pair of magnetic, generally parallel side surfaces comprise at least one hook for hanging tools.
